(19) United States
(12) Patent Application Publication
(10) Pub. No.: US 2024/0239191 A9
(43) Pub. Date: Jul. 18, 2024

(54) Method and System for Automatized Selection and Documentation of Personal Highlights During Journeys with a Motor Vehicle

(71) Applicants: Hyundai Motor Company, Seoul (KR); Kia Corporation, Seoul (KR)

(72) Inventors: Lukas Gaß, Mainz (DE); Javier Augusto Romero-Leon, Saline, MI (US); Margaux A. Krause, Brighton, MI (US); Tarek Matt, Canton, MI (US); John Meyendorff, South Lyon, MI (US); John Molnar, Farmington Hills, MI (US); Henry Teutsch, Detroit, MI (US); Michael Schreiber, Frankfurt am Main (DE); Ingmar Langer, Darmstadt (DE); Mert Uzungece, Mainz (DE); Adrian Bablok, Wiesbaden (DE); Joel Dammel, Rüsselsheim (DE); Amanda Christiana, Ann Arbor, MI (US); Victoria Delker, Farmington Hills, MI (US)

(21) Appl. No.: 18/349,589

(22) Filed: Jul. 10, 2023

(30) Foreign Application Priority Data
Oct. 21, 2022 (DE) 10202221168.0

(51) Int. Cl. B60K 35/00; G07C 5/08

(52) U.S. Cl. CPC B60K 35/00; G07C 5/0841; B60K 2370/165; B60K 2370/56

(57) ABSTRACT

An embodiment method for automatized selection and documentation of personal highlights during journeys with a vehicle includes capturing journey data during a journey of the vehicle, the journey data including audio, image, or video data taken of an interior or an exterior of the vehicle, storing selected aspects of the journey data to a non-transient data storage in response to a trigger criteria being met during the journey in an associated driving situation, and generating a selection of personal journey highlights based on the selected aspects stored during the journey for presentation during or after the journey.

### CROSS-REFERENCE TO RELATED APPLICATIONS

This application claims the benefit of German Patent Application No. 102022211168.0, filed on Oct. 21, 2022, which application is hereby incorporated herein by reference.

### TECHNICAL FIELD

The present invention pertains to a method and a system for automatized selection and documentation of personal highlights during journeys with a motor vehicle and to a motor vehicle with such a system.

### BACKGROUND

During trips or journeys with motor vehicles sometimes special moments occur that would be worthwhile to preserve in the form of pictures, videos, and/or sound recordings. These recordings then could be posted on social media and/or stored in a personal repository for later usage. However, it can be challenging during trips to take photos or other recordings at the right time. Hence, there is a chance that beautiful or otherwise worthwhile memories could be missed and thus get lost. Furthermore, safety issues may come up in case that the driver tries to make a recording.

It would be beneficial if corresponding social media content could be readily available during or at least immediately after a trip. However, editing photos, videos, and other recordings may be time consuming if done manually. Moreover, due to the number of pictures or videos taken, it may happen that the recordings will be lost for all practical purposes because sorting out may be too time-consuming and the actually relevant moments may get drowned by irrelevant and/or redundant information.

Current motor vehicles are increasingly connected with various sensors in order to implement advanced driver-assistance systems and/or autonomous driving functionalities. For example, cars may be provided with multiple sensors and various techniques for acquiring data from the environment, e.g., to provide accurate detection of other vehicles, of the road ahead and/or behind and so on. Typical technologies that are utilized for this purpose include cameras and microphones amongst others to monitor the interior and/or the exterior of the respective vehicle. In addition, various other sensor technologies like radar, laser, lidar, and ultrasound and so on are employed to get a more detailed view of the immediate vicinity of the vehicle. These data and information however usually cannot be used for personal purposes.

Lync & Co offers a so-called “journey camera” relying on built-in cameras in order to take selfies or capture an exterior view. Recorded photos and videos can be shared immediately with a computer or smartphone for easy social media posting. However, the journey camera has to be activated manually and cannot be used while driving to avoid distraction.

### SUMMARY

Hence, there is a need to find solutions for documenting car related journeys in an automatized fashion.

According to one embodiment of the invention, a method for automatized selection and documentation of personal highlights during journeys with a motor vehicle comprises capturing journey data during a journey of the motor vehicle, the journey data comprising at least one of audio, image and video data taken of an interior and/or an exterior of the motor vehicle, storing selected aspects of the journey data to a non-transient data storage in case at least one of several given trigger criteria is met during the journey in an associated driving situation, and generating a selection of personal journey highlights based on the selected aspects stored during the journey for presentation to a travel passenger of the motor vehicle during and/or after the journey.

According to another embodiment of the invention, a system for automatized selection and documentation of personal highlights during journeys with a motor vehicle comprises a control device configured to access journey data captured during a journey of the motor vehicle, the journey data comprising at least one of audio, image and video data taken of an interior and/or an exterior of the motor vehicle, to store selected aspects of the journey data to a non-transient data storage in case at least one of several given trigger criteria is met during the journey in an associated driving situation, and to generate a selection of personal journey highlights based on the selected aspects stored during the journey for presentation to a travel passenger of the motor vehicle during and/or after the journey.

According to yet another embodiment of the invention, a motor vehicle comprises a system according to embodiments of the invention.

One embodiment of the present invention automatizes media content preparation of car related journeys to save time and to provide attractive content for social media. The vehicle accesses audio and/or visual information (e.g., recorded by a device installed inside or outside the vehicle and/or by a personal electronic device of a vehicle occupant) and automatically determines which content might be interesting to create a highlight selection of the journey, e.g., one or several videos, several pictures, etc., based on certain trigger criteria, e.g., the passing of certain points of interest along a route, notable social interaction between the occupants of the vehicle, etc. The driver can then put his/her attention on driving (less distraction and increased safety). A time consuming manual selection of content after the journey is not necessary anymore. Content can be captured continuously and solely the interesting elements may be stored to reduce required storage.

Embodiments of the invention can offer added value due to additional content provided by vehicle sensors and systems (e.g., infotainment) compared to pictures/videos taken manually with a smartphone or the like. The automatically generated final highlights may be modified and posted during or after the trip. The vehicle can offer selected extracts (e.g., a photo) while driving via audio/visual and/or navigation functions in real time. At the end of the trip, the system may provide for example a video with all highlights from the trip. These features may also be deployed on demand, e.g., for a limited period of time when going on a road trip with a rental car.

It is understood that the term “vehicle” or “vehicular” or other similar term as used herein is inclusive of motor vehicles in general such as passenger automobiles including sport utility vehicles (SUVs), buses, trucks, various commercial vehicles, and the like, and includes hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, both gasoline-powered and electric-powered vehicles.

Advantageous embodiments and improvements of the present invention are found in the description and claims.

According to an embodiment of the invention, a vehicle sensor system of the motor vehicle may be configured to capture the journey data continuously during the journey. The selected aspects of the journey data may comprise selected audio and/or video streams of limited length and/or selected images documenting the associated driving situation.

Hence, for example, a dashcam and/or interior camera may record (and overwrite) data continuously and then save only selected short videos of a certain length (several seconds, e.g., 30 s) to the non-transient data storage in order to keep the amount of accumulated data low and to preserve only the most important events of a trip, thereby also saving storage space.

According to an embodiment of the invention, the control device may be configured to retrieve the journey data from a personal electronic device of a travel passenger of the motor vehicle.

Hence, journey data may not only comprise data recorded by systems of the vehicle. Additionally, or alternatively, journey data may also be taken from smartphones, smartwatches, and other personal electronic devices of the vehicle occupants. To this end, the data may be retrieved wirelessly from these devices by the vehicle.

According to an embodiment of the invention, the control device may be configured to set the trigger criteria based on pre-established and/or user defined content criteria.

For example, a user may be interested in certain points of interest (POIs) along a route of the vehicle. A list of these POIs may be entered into the system before a trip and may form the basis for trigger criteria. Vehicle sensors may then trigger a recording, e.g., several photos, a short video, etc., as soon as the vehicle approaches or passes the respective POI. Alternatively, one or several cameras (interior as well as exterior) of a vehicle may record continuously during a trip. In that case the recorded data may be repeatedly overwritten and/or deleted as long as no trigger is fired, for example after a certain time period, e.g., a few or some seconds like 30 s for example.

According to an embodiment of the invention, the control device may be configured to successively refine the trigger criteria based on machine learning algorithms taking user preferences and/or user interaction into account.

Thus, the system may learn the user's preferences depending on a user's interaction with the system and may then optimize selection/trigger criteria on this basis. Such user interaction may comprise, for example, manual editing of recorded selected aspects of the journey data and/or of the trigger criteria, deleting and/or accepting the suggested content, and so on.

According to an embodiment of the invention, the trigger criteria may comprise the occurrence of at least one of the following during the journey: passing of points of interest along a route of the motor vehicle; notable traffic and/or driving situations involving the motor vehicle or happening in the vicinity of the motor vehicle; notable behavior of a travel passenger of the motor vehicle; notable interactions between travel passengers of the motor vehicle; notable interactions between the travel passengers of the motor vehicle and the motor vehicle; trigger signals from personal electronic devices of the travel passengers; and ingress and/or egress of travel passengers of the motor vehicle.

For example, an event worth keeping may comprise driving on a scenic road. In that case, a current GPS location and/or other navigation/map data may serve as trigger. The system may then decide to record one or several videos with an exterior camera of the vehicle. However, other trigger possibilities also come to mind, e.g., low speed when passing, trigger words by the occupants, visual information from the vehicle systems, activation of smartphones, i.e., pictures are also taken with smartphones, manual cameras, etc.

Phases of racy or sporty driving during a trip may also trigger the recording of audio and/or visual information. Possible triggers for such events include the activation of a sports mode, high accelerations, and/or lateral forces, for example.

Other notable driving situations may comprise the passing of a certain rare or spectacular vehicle, e.g., a vintage vehicle, an exotic sports car, which may get detected by the vehicle systems (sound of passing car, visual information) and/or due to the behavior of the occupants (voice—trigger words, exclamatory remarks, gaze direction, pointing fingers, window opening etc.).

Notable behavior and/or interactions may comprise singing, laughing, and the like. Potential triggers would thus comprise certain trigger words, songs, sound volume/level of conversation, and the like.

Notable interactions between the travel passengers of the motor vehicle and the motor vehicle may comprise, for example, the opening of a sunroof, the activation of a certain driving mode, e.g., a sports mode, and so on.

Trigger signals from personal electronic devices of the travel passengers may comprise, for example, certain signals from electronic devices, in particular portable electronic devices including smartwatches, smartphones, and so on. In principle, signals and/or interactions with any external device, that is, any device not integrated in the vehicle, may serve as triggers for the present purpose.

Moreover, vehicle standstill, opening of doors, seat occupation sensors and similar may indicate that an occupant is entering or leaving the vehicle, which may then also trigger storage of related pictures and/or audio information.

According to an embodiment of the invention, the journey data may comprise a driving history of the motor vehicle. The driving history may comprise navigation data, environmental data, driving parameters and/or status data of the motor vehicle. The control device may be configured to store the selected aspects of the journey data together with associated aspects of the driving history.

For example, visual information of a POI could be accompanied by the corresponding GPS and/or travel data in order to assemble an interactive route of a journey. In a similar vein, the route along a scenic landscape may be stored together with pictures and other information from selected points of the route. Such further information may include without limitation weather data, parking information, and driving data like acceleration, speed, etc.

According to an embodiment of the invention, the control device may be configured to block journey data with sensitive content from storage.

For example, if the system determines that an accident happens in the vicinity of the vehicle and/or in case the vehicle passes such an event, the system may decide to delete visual and audio information from the exterior of the vehicle for a certain duration. A corresponding trigger may be based on official police information, visual data from the accident, etc.

In another example, certain interactions within the vehicle may be deemed inappropriate for storage, e.g., due to the delicate content of a discussion and/or behavior of the occupants. This may be triggered, for example, by the occurrence of certain trigger words.

According to an embodiment of the invention, the journey data may comprise external data captured by other motor vehicles in the vicinity of the motor vehicle during a respective driving situation. The control device may be configured to do at least one of the following: wirelessly receive the external data from the other motor vehicles and to consider the external data for the selected aspects of the journey data; and wirelessly share aspects of the journey data and/or data about user preferences and/or user interactions with other motor vehicles.

Hence, information from other vehicles can be used as trigger and/or recorded content for the system of the vehicle. For example, a video shot from the perspective of another vehicle may be transferred to the present vehicle and stored as part of the selected aspects of the journey data. Similarly, certain information provided by another vehicle may be used as trigger information. In yet another example, any data relevant for training some of the employed machine learning algorithms may be shared by other vehicles to optimize trigger/selection criteria. All of these data may of course also be shared by the present vehicle with other vehicles for these purposes.

Embodiments of the invention will be explained in greater detail with reference to exemplary embodiments depicted in the drawings as appended.

### BRIEF DESCRIPTION OF THE DRAWINGS

The accompanying drawings are included to provide a further understanding of embodiments of the present invention and are incorporated in and constitute a part of this specification. The drawings illustrate the embodiments of the present invention and together with the description serve to explain the principles of the invention. Other embodiments of the present invention and many of the intended advantages of embodiments of the present invention will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a motor vehicle equipped with a system for selection and documentation of personal highlights according to an embodiment of the invention.

FIG. 2 schematically shows a flow diagram of a method for automatized selection and documentation of personal highlights during journeys with the motor vehicle of FIG. 1.

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

The following reference identifiers may be used in connection with the accompanying drawings to describe exemplary embodiments of the present disclosure.
1 system for selection and documentation of personal highlights
2 vehicle sensor system
2a interior camera
2b exterior camera
2C microphone
3 control device
4 non-transient data storage
5 driver interface
6 journey data
7 driving history
8 communication unit
9 machine learning algorithm
10 motor vehicle
11 other vehicles/vehicle fleet
M method
M1-M3 method steps

### DETAILED DESCRIPTION OF ILLUSTRATIVE EMBODIMENTS

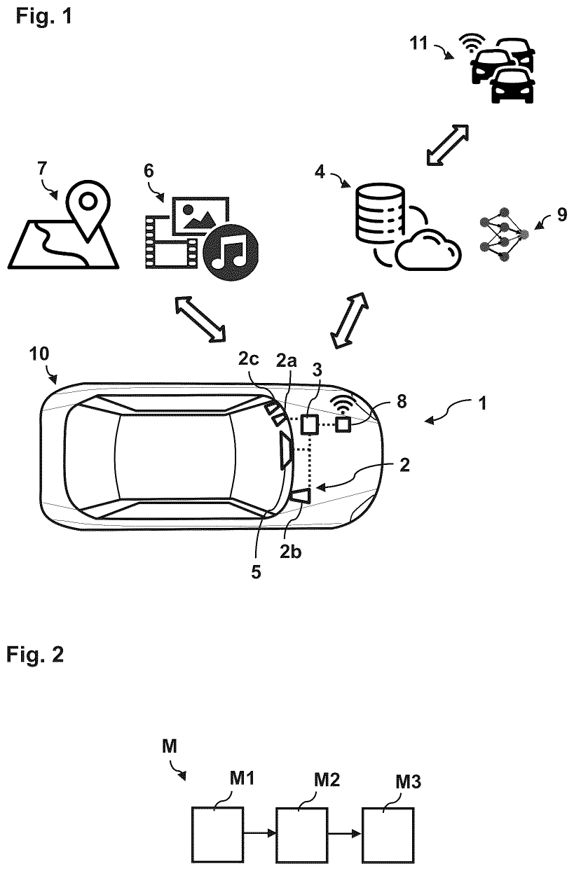

FIG. 1 schematically depicts a motor vehicle 10 equipped with a system 1 for selection and documentation of personal highlights according to an embodiment of the invention. FIG. 2 schematically shows a flow diagram of a method M for automatized selection and documentation of personal highlights during journeys with the motor vehicle 10 of FIG. 1.

The present method M and system 1 are provided to automatize the selection and documentation of highlights during car-related journeys. Conventionally, vehicle occupants need to take pictures/videos and audio recordings manually and then need to look through all recorded information later on to select and sort out any particularly worthwhile information for long-term storage, e.g., to produce a selection of highlights from a particular vacation. With the present system 1, integrated vehicle systems are used to automatically check if a current driving situation inside and/or around the motor vehicle 10 has the potential for a notable event worthwhile to be recorded. Only in case certain trigger conditions are met, audio and/or visual information are stored as part of the highlights of the respective journey and are then automatically selected for presentation to the users, who then can decide on the basis of these pre-selected data whether they want to keep them or not, whether to upload them to social media, etc. By adequately training and adjusting the configuration of the pre-selection, users may not even need to further select the acquired material at all anymore.

To this end, the present system 1 comprises a vehicle sensor system 2 configured to capture audio, image and/or video data of an interior and/or an exterior of the motor vehicle 10 during a journey of the motor vehicle 10. In the exemplary embodiment of FIG. 1, the sensor system 2 comprises an interior camera 2a, an exterior camera 2b, and a microphone 2C. It is to be understood of course that the sensor system 2 may comprise various other sensors and sensor technologies comprising amongst others ultrasound, radar, laser, lidar and so on. The sensor system 2 may also be communicatively coupled to and/or integrated in further vehicle systems, e.g., an assisted/autonomous driving system, an infotainment system, a navigation system and so on, and may thus also rely on the data acquired by and/or available to these systems.

The vehicle sensor system 2 may be particularly configured to capture the journey data 6 continuously during the journey. The data may be temporarily saved in a transient data storage, e.g., a memory, and be continuously overwritten there. Only in case certain requirements are fulfilled the data may then be transferred to a non-transient data storage for mid-term (e.g., until the end of the journey) or long-term storage.

Consequently, the system 1 further comprises a control device 3 configured to store selected aspects of the journey data 6 to a non-transient data storage 4 in case at least one of several given trigger criteria is met during the journey in an associated driving situation. The non-transient data storage 4 may be integrated in the vehicle 10 itself. However, also distributed and/or cloud storage solutions may be employed for the present purpose. To this end, the vehicle 10 may be provided with a communication unit 8 that provides a wireless connection to the corresponding data networks.

The system 1 then is adapted to generate a selection of personal journey highlights based on the selected aspects stored during the journey for presentation to a travel passenger (also including the driver) of the motor vehicle 10 during and/or after the journey, e.g., on a driver interface 5 as shown in FIG. 1. These selected aspects of the journey data 6 may comprise amongst others selected audio and/or video streams of limited length and/or selected images documenting the associated driving situation.

Additionally, or alternatively, the journey data may also be taken from personal electronic devices of the travel passengers of the motor vehicle. In that case, the control device 3 may access the respective devices of the occupants, e.g., a smartphone or the like.

The corresponding method M shown in FIG. 2 thus comprises under M1 capturing the journey data 6 with the vehicle sensor system 2, under M2 storing the selected aspects of the journey data 6 to the non-transient data storage 4 in case at least one of several given trigger criteria is met during the journey in an associated driving situation, and under M3 generating the selection of personal journey highlights based on the selected aspects stored during the journey for presentation to a travel passenger of the motor vehicle 10 during and/or after the journey.

The journey data 6 may further comprise a driving history 7 of the motor vehicle 10 comprising, for example, navigation data (GPS coordinates, routes, etc.), environmental data (e.g., weather information, etc.), driving parameters (acceleration, speed profiles, etc.) and status data (sports mode, autonomous mode, etc.) of the motor vehicle 10. The selected aspects of the journey data 6 may be stored together with associated aspects of the driving history 7. For example, information about a passed point of interest may be stored together with the audio and visual information captured during the passing. Moreover, the recorded audio and/or visual information may be accompanied by further entertainment data, e.g., background music and/or sound effects in case of a video (e.g., of a video recorded during sports mode).

The trigger criteria may, for example, comprise the occurrence of at least one of the following during the journey: passing of points of interest along a route of the motor vehicle 10 (e.g., a scenic view, a certain building or monument, etc.); notable traffic and/or driving situations involving the motor vehicle 10 or happening in the vicinity of the motor vehicle 10 (e.g., an exotic car passing, cornering, rough off-road driving, a spectacular and/or thrilling route with cliffs, bridges, rivers, etc.); notable behavior of a travel passenger of the motor vehicle 10 (e.g., telling of a joke or of a story, laughter, singing, etc.); notable interactions between travel passengers of the motor vehicle 10 (e.g., singing, laughter, discussions, etc.); notable interactions between the travel passengers of the motor vehicle and the motor vehicle (e.g., activation of sports driving mode, opening of a sunroof, etc.); trigger signals from personal devices of the travel passengers (e.g., signals from personal electronic devices like smartphones, smartwatches, etc.); and ingress and/or egress of travel passengers of the motor vehicle 10.

However, certain sensitive contents may also be selectively blocked from storage under specific circumstances, e.g., visual data in case of an accident.

The trigger criteria may be set based on pre-established and/or user defined content criteria, e.g., certain topics of interest. At the end of the journey, the selected data may then be summarized, e.g., in the form of a video clip, and may be uploaded to various social media or personal data repositories. Users may also be able to decide whether to keep certain elements, edit them, and/or delete them. The trigger criteria may also be successively refined based on machine learning algorithms 9 taking such user preferences and/or user interaction into account.

The journey data may be supplemented and/or substituted by wirelessly received external data captured by other motor vehicles 11 in the vicinity of the motor vehicle 10 during a respective driving situation. These external data may then be considered for the selected aspects of the journey data 6.

In a similar vein, the present vehicle 10 may wirelessly share aspects of the journey data 6 and/or data about user preferences and/or user interaction with other motor vehicles 11. The vehicles 10, 11 may thus share any relevant information, which may be particularly used to further optimize the data selection and documentation process (e.g., with regards to the employed machine learning algorithms 9).

In the foregoing detailed description, various features are grouped together in one or more examples with the purpose of streamlining the disclosure. It is to be understood that the above description is intended to be illustrative, and not restrictive. It is intended to cover all alternatives, modifications, and equivalents of the different features and embodiments. Many other examples will be apparent to one skilled in the art upon reviewing the above specification. The embodiments were chosen and described in order to explain the principles of the invention and its practical applications, to thereby enable others skilled in the art to utilize the invention and various embodiments with various modifications as are suited to the particular use contemplated.

What is claimed is:

1. A method for automatized selection and documentation of personal highlights during journeys with a vehicle, the method comprising:
capturing journey data during a journey of the vehicle, the journey data comprising audio, image, or video data taken of an interior or an exterior of the vehicle;
storing selected aspects of the journey data to a non-transient data storage in response to a trigger criteria being met during the journey in an associated driving situation; and
generating a selection of personal journey highlights based on the selected aspects stored during the journey for presentation during or after the journey.

2. The method according to claim 1, wherein the journey data is captured continuously during the journey by a vehicle sensor system of the vehicle, and wherein the selected aspects of the journey data comprise selected audio or video streams of limited length or selected images documenting the associated driving situation.

3. The method according to claim 1, wherein the journey data is retrieved from a personal electronic device of an occupant of the vehicle.

4. The method according to claim 1, wherein the trigger criteria is set based on pre-established or user defined content criteria.

5. The method according to claim 4, wherein the trigger criteria is successively refined based on machine learning algorithms taking user preferences or user interactions into account.

6. The method according to claim 1, wherein the trigger criteria comprises an occurrence of passing of points of interest along a route of the vehicle, notable traffic or driving situations involving the vehicle or happening near the vehicle, notable behavior of an occupant of the vehicle, notable interactions between multiple occupants of the vehicle, notable interactions between the occupant of the vehicle and the vehicle, trigger signals from a personal electronic device of the occupant, or ingress or egress of the occupant of the vehicle.

7. The method according to claim 1, wherein the journey data comprises a driving history of the vehicle, wherein the driving history comprises navigation data, environmental data, driving parameters, or status data of the vehicle, and wherein the selected aspects of the journey data are stored together with associated aspects of the driving history.

8. The method according to claim 1, wherein the journey data having sensitive content is blocked from storage.

9. The method according to claim 1, wherein the journey data comprises external data captured by other vehicles in an area of the vehicle during a respective driving situation, and wherein the method further comprises:
wirelessly receiving the external data from the other vehicles and considering the external data for the selected aspects of the journey data; or
wirelessly sharing the selected aspects of the journey data or data about user preferences or user interactions with the other vehicles.

10. A system for automatized selection and documentation of personal highlights during journeys with a vehicle, the system comprising:
a control device configured to:
access journey data captured during a journey of the vehicle, the journey data comprising audio, image, or video data taken of an interior or an exterior of the vehicle;
store selected aspects of the journey data to a non-transient data storage in response to a trigger criteria being met during the journey in an associated driving situation; and
generate a selection of personal journey highlights based on the selected aspects stored during the journey for presentation during or after the journey.

11. The system according to claim 10, further comprising a vehicle sensor system configured to capture the journey data continuously during the journey, wherein the selected aspects of the journey data comprise selected audio or video streams of limited length or selected images documenting the associated driving situation.

12. The system according to claim 10, wherein the control device is configured to retrieve the journey data from a personal electronic device of an occupant of the vehicle.

13. The system according to claim 10, wherein the control device is configured to set the trigger criteria based on pre-established or user defined content criteria.

14. The system according to claim 10, wherein the control device is configured to successively refine the trigger criteria based on machine learning algorithms taking user preferences or user interactions into account.

15. The system according to claim 10, wherein the trigger criteria comprises an occurrence of passing of points of interest along a route of the vehicle, notable traffic or driving situations involving the vehicle or happening in an area of the vehicle, notable behavior of an occupant of the vehicle, notable interactions between multiple occupants of the vehicle, notable interactions between the occupant of the vehicle and the vehicle, trigger signals from a personal electronic device of the occupant, or ingress or egress of the occupant of the vehicle.

16. The system according to claim 10, wherein the journey data comprises a driving history of the vehicle, wherein the driving history comprises navigation data, environmental data, driving parameters, or status data of the vehicle, and wherein the control device is configured to store the selected aspects of the journey data together with associated aspects of the driving history.

17. The system according to claim 10, wherein the control device is configured to block the journey data having sensitive content from storage.

18. The system according to claim 10, wherein the journey data comprises external data captured by other vehicles in an area of the vehicle during a respective driving situation, and wherein the control device is configured to:
wirelessly receive the external data from the other vehicles and to consider the external data for the selected aspects of the journey data; or
wirelessly share the selected aspects of the journey data or data about user preferences or user interactions with the other vehicles.

19. A vehicle comprising:
a vehicle sensor system; and
a control device configured to:
access journey data captured during a journey of the vehicle, the journey data comprising audio, image, or video data taken of an interior or an exterior of the vehicle;
store selected aspects of the journey data to a non-transient data storage in response to a trigger criteria being met during the journey in an associated driving situation; and
generate a selection of personal journey highlights based on the selected aspects stored during the journey for presentation during or after the journey.

20. The vehicle according to claim 19, wherein the vehicle sensor system is configured to capture the journey data continuously during the journey, and wherein the selected aspects of the journey data comprise selected audio or video streams of limited length or selected images documenting the associated driving situation.
